(19) United States
(12) Patent Application Publication
(10) Pub. No.: US 2009/0238264 A1
(43) Pub. Date: Sep. 24, 2009

(54) SYSTEM AND METHOD FOR REAL-TIME TRANSCODING OF DIGITAL VIDEO FOR FINE GRANULAR SCALABILITY

(75) Inventors: Karl R. Wittig, New York, NY (US); Richard Y. Chen, Croton on Hudson, NY (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 11/721,232

(22) PCT Filed: Dec. 8, 2005
(86) PCT No.: PCT/IB05/54131

§ 371 Date: Jun. 8, 2007

Related U.S. Application Data
(60) Provisional application No. 60/635,212, filed on Dec. 10, 2004.

(51) Int. Cl. H04N 7/26

(52) U.S. Cl. 375/240.03; 375/240.26; 375/E07.198; 375/E07.139

(57) ABSTRACT

A video transcoder (500) is presented for transcoding a previously coded digital video data stream into a layered stream consisting of a base layer having a lower data rate than the original source stream and an enhancement layer encoded using Fine-Granular Scalability (FGS) techniques. The video transcoder (500) comprises an efficient means for re-encoding existing digital video into FGS multilayer video to provide variable levels of displayed picture quality under conditions of changing bandwidth degradation in wireless and/or wireline networks.

The present invention relates to an apparatus and a related method for transcoding a previously coded digital video data stream into a layered stream consisting of a base layer having a lower data rate than the original source stream and an enhancement layer encoded using Fine-Granular Scalability (FGS) techniques. The present invention comprises an efficient means for re-encoding existing digital video into FGS multilayer video to provide variable levels of displayed picture quality under conditions of changing bandwidth degradation in wireless and/or wireline networks.

Digital streaming video may be transmitted using a video coding standard, such as MPEG, over a channel in which the available bandwidth is time-varying and location dependent. This frequently occurs in wireless networks, but may also occur in a wireline networks in which bandwidth is limited. When the available bandwidth is less than the minimum level required for the data rate of the video stream being sent over the network, degradation of the displayed video results.

This problem may be solved by change the data rate of the pre-coded video content according to channel conditions. This technique is known as trans-rating. However, trans-rating requires fast and accurate predictions of channel capacity, which is difficult to obtain. Consequently, there still are occasions when a mismatch between channel capacity and the video source data rate occurs, which results in a loss of video packets.

Prioritized streaming technologies can better adapt to varying channel capacity. In prioritized streaming, the essential (or base layer) information is encoder according to one embodiment of the prior art;

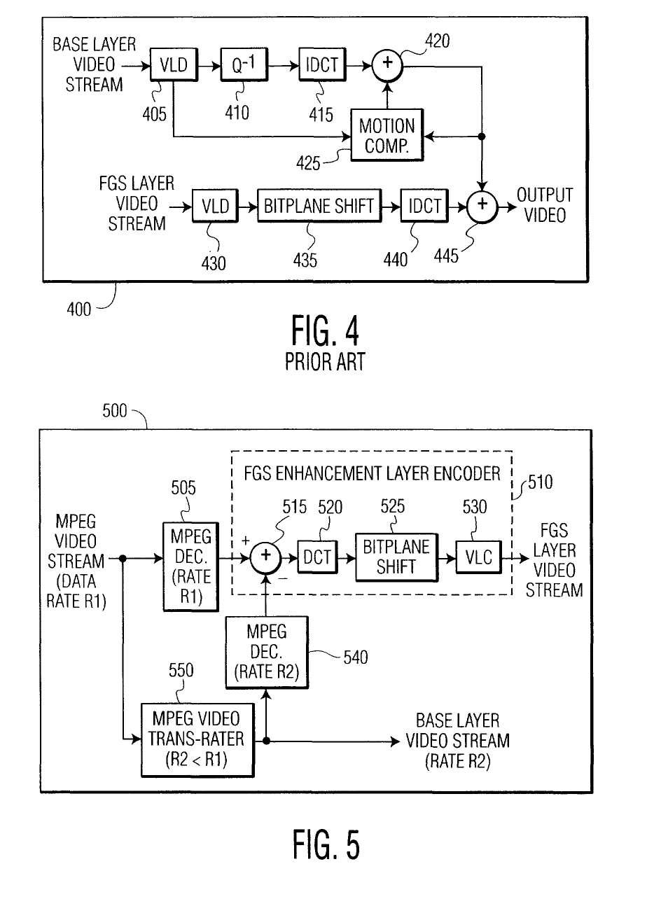

FIG. 4 illustrates an exemplary fine granular scalability (FGS) decoder according to one embodiment of the prior art;

FIG. 5 illustrates an exemplary transcoder for fine granular scalability (FGS) according to one embodiment of the present invention; and

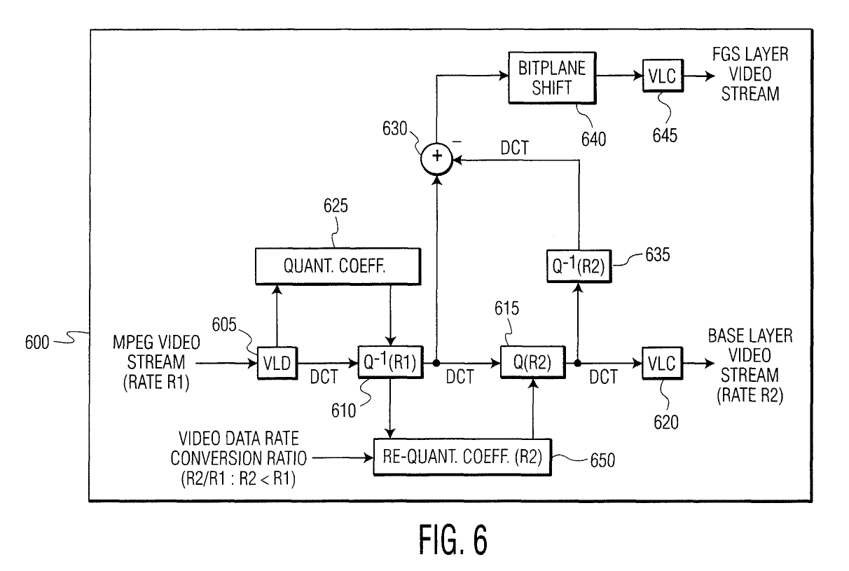

FIG. 6 illustrates an exemplary transcoder for fine granular scalability (FGS) according to another embodiment of the present invention.

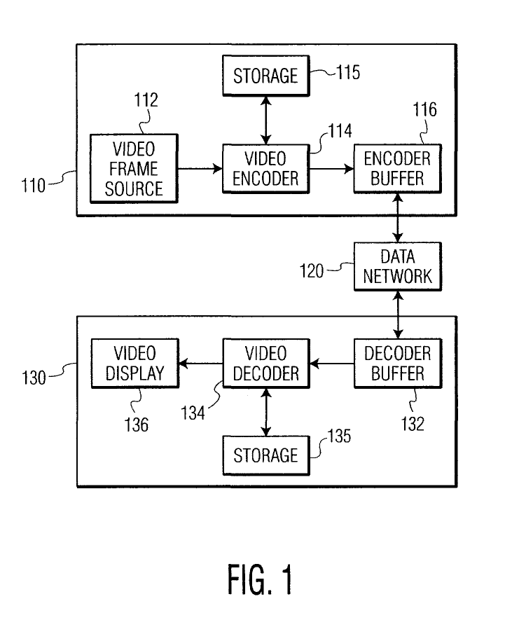

FIGS. 1 through 6, discussed below, and the various embodiments described in this patent document are by way of illustration only and should not be construed in any way to limit the scope of the invention. Those skilled in the art will understand that the principles of the invention may be implemented in any suitably arranged apparatus, device, or structure.

FIG. 1 illustrates a video transmission system for an end-to-end transmission of streaming video from streaming video transmitter 110 through data network 120 to one or more streaming video receivers, such as exemplary streaming video receiver 130, according to one embodiment of the present invention. Depending on the application, streaming video transmitter 110 may be any one of a wide variety of sources of video frames, including a data network server, a television station transmitter, a cable network, a desktop personal computer (PC), or the like.

Streaming video transmitter 110 comprises video frame source 112, video encoder 114, storage 115, and encoder buffer 116. Video frame source 112 may be any device capable of generating a sequence of uncompressed video frames, including a television antenna and receiver unit, a video cassette player, a video camera, a disk storage device capable of storing a video clip, and the like. The uncompressed video frames enter video encoder 114 at a given picture rate (or streaming rate) and are compressed according to any known compression algorithm or device, such as an MPEG-4 encoder. Video encoder 114 then transmits the compressed video frames to encoder buffer 116 for buffering in preparation for transmission across data network 120.

Data network 120 may be any suitable network and may include portions of both public data networks, such as the Internet, and private data networks, such as an enterprise-owned local area network (LAN) or a wide area network (WAN). In an advantageous embodiment of the present invention, data network 120 comprises a wireless network. In particular, data network 120 may be a wireless home network

Streaming video receiver 130 comprises decoder buffer 132, video decoder 134, storage 135, and video display 136. Depending on the application, streaming video receiver may be any one of a wide variety of receivers of video frames, including a television receiver, a desktop personal computer (PC), a video cassette recorder (VCR), or the like. Decoder buffer 132 receives and stores streaming compressed video frames from data network 120. Decoder buffer 132 then transmits the compressed video frames to video decoder 134 as required. Video decoder 134 decompresses the video frames at the same rate (ideally) at which the video frames were compressed by video encoder 114. Video decoder 134 sends the decompressed frames to video display 136 for play-back on the screen of video display 134.

In an advantageous embodiment of the present invention, video encoder 114 may represent a standard MPEG encoder implemented using any hardware, software, firmware, or combination thereof, such as a software program executed by a conventional data processor. In such an implementation, video encoder 114 may comprise a plurality of computer executable instructions stored in storage 115. Storage 115 may comprise any type of computer storage medium, including a fixed magnetic disk, a removable magnetic disk, a CD-ROM, magnetic tape, video disk, and the like. Furthermore, in an advantageous embodiment of the present invention, video decoder 134 also may represent a conventional MPEG decoder implemented using any hardware, software, firmware, or combination thereof, such as a software program executed by a conventional data processor. In such an implementation, video decoder 134 may comprise a plurality of computer executable instructions stored in storage 135. Storage 135 also may comprise any type of computer storage medium, including a fixed magnetic disk, a removable magnetic disk, a CD-ROM, magnetic tape, video disk, and the like.

Due to variations in the available bandwidth in data network 120, it is necessary to transcode video data in video encoder 114 using fine granular scalability (FGS) according to the principles of the present invention. Trans-rating and FGS are briefly described herein. Trans-rating consists of the direct re-encoding of an existing (original) video stream to a new video stream having a lower data rate than the original. The new lower-rate video stream may be correctly decoded and displayed with only a reduction in image quality relative to that of the original stream. This is a widely-used scheme for reducing the data rate of a video stream when the available transmission bandwidth is less than the full data rate of the original stream.

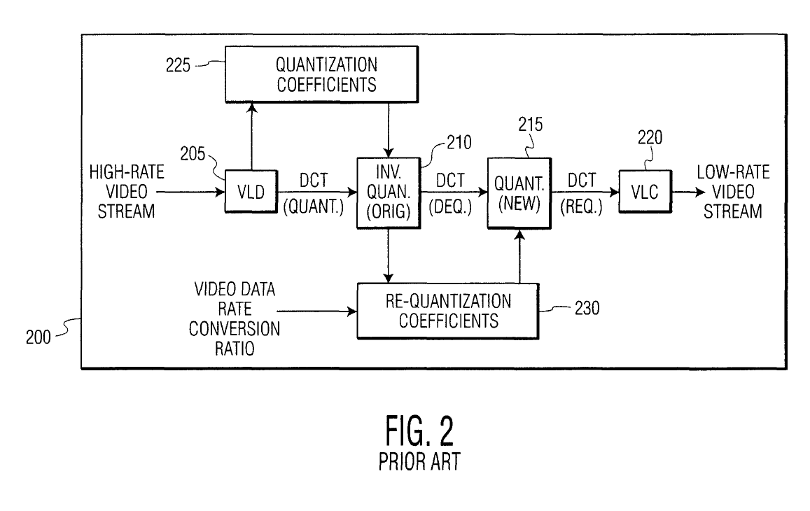

FIG. 2 illustrates an exemplary video data transrater (or transcoder) 200 according to one embodiment of the prior art. Transrater 200 comprises variable-length decoder 205, inverse quantization circuit 210, quantization circuit 215, variable-length coder (VLC) 220, quantization coefficients block 225 and re-quantization coefficients block 230. VLD 205 receives a high-rate video stream and decodes the stream to produce the quantized discrete cosine transform (DCT) coefficients. VLD 205 also extracts the quantization coefficients from the stream or identifies predefined quantization coefficients, and the quantization coefficients are stored in quantization coefficients block 225. Inverse quantization circuit 210 receives the quantized DCT coefficients and uses the quantization coefficients from quantization coefficients block 225 to produce de-quantized DCT coefficients.

Re-quantization coefficients block 230 determines new (or re-quantization) coefficients suited to the new, lower video data rate (i.e., video data rate conversion ratio). Quantization circuit 215 uses the re-quantization coefficients to re-quantize the output of inverse quantization circuit 210, thereby producing a stream of re-quantized DCT coefficients. Variable-length coder (VLC) 220 then encodes the re-quantized DCT coefficients to produce the desired low-rate video stream.

Transrater 200 decodes the original video stream to the extent necessary to identify and evaluate the quantized DCT coefficients, along with the associated quantization factors, so that the original coefficient values can be readily computed. Given the data rate of the original stream and the desired rate of the trans-rated video stream, re-quantization coefficients block 230 computes a new quantization factor for each coefficient. Quantization circuit 215 then scales the de-quantized DCT stream by this factor. In this manner, a video stream having the same content as the original stream, but a lower data rate and a correspondingly lower image quality, is generated for transmission under network bandwidth conditions that correspond to the lower rate. However, due to the complexity of the trans-rating algorithm, it is typically implemented using a special-purpose processor.

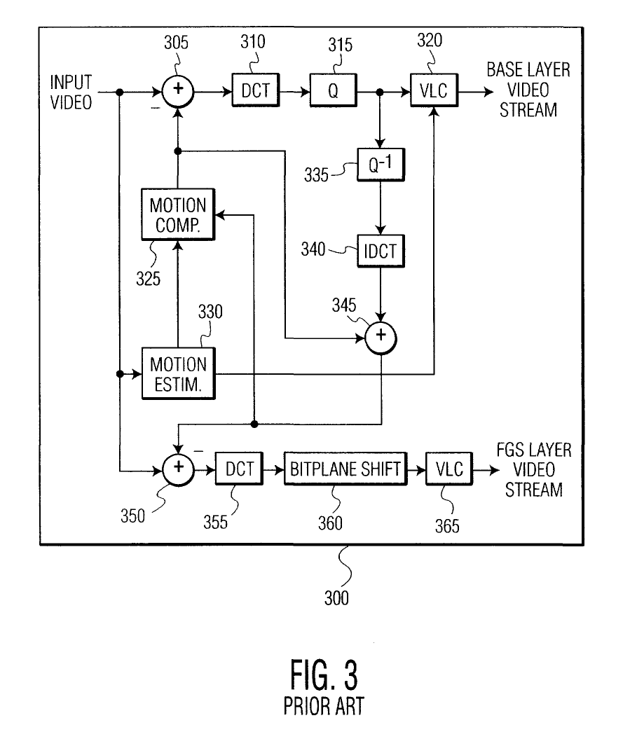

FIG. 3 illustrates exemplary fine granular scalability (FGS) encoder 300 according to one embodiment of the prior art. FGS encoder 300 comprises adder 305, discrete cosine transform (DCT) circuit 310, quantization circuit 315, variable length coder (VLC) 320, motion compensation block 325, and motion estimator 330. FGS encoder 300 further comprises inverse quantization (Q⁻¹) circuit 335, inverse discrete cosine transform (IDCT) circuit 340, adder 345, adder 350, discrete cosine transform (DCT) circuit 355, bitplane shift circuit 360, and variable length coder (VLC) 365.

Motion estimation circuit 330 receives the original video signal and estimates the amount of motion between a reference frame provided and a current present video frame as represented by changes in pixel characteristics. For example, the MPEG standard specifies that motion information may be represented by one to four spatial motion vectors per 16×16 sub-block of the frame. Motion compensation circuit 325 receives the motion estimates from motion estimation circuit 330 and generates motion compensation factors that are subtracted from the original input video signal by adder (or combiner) 305.

DCT circuit 310 receives the resultant output from adder 305 and transforms it from a spatial domain to a frequency domain using known techniques such as discrete cosine transform (DCT). Quantization circuit 315 receives the original DCT coefficient outputs from DCT circuit 310 and further compresses the motion compensation prediction information using well-known quantization techniques. Quantization circuit 315 determines a division factor to be applied for quantization of the transform output.

Variable length coder (VLC) 320, which may be, for example, an entropy coding circuit, receives the quantized DCT coefficients from quantization circuit 315 and further compresses the data using variable-length coding techniques that represent areas with a high probability of occurrence with a relatively short code and that represent areas of lower probability of occurrence with a relatively long code. The output of VLC 320 comprises the base-layer video stream.

Inverse quantization circuit 335 de-quantizes the output of quantization circuit 315 to produce a signal that represents the transform input to quantization circuit 315. This signal comprises the reconstructed base layer DCT coefficients. As is well known, the inverse quantization process is a “lossy” process, since the bits lost in the division performed by quantization circuit 315 are not recovered. Inverse discrete cosine transform (IDCT) circuit 340 decodes the output of inverse quantization circuit 335 to produce a signal which provides a frame representation of the original video signal, as modified by the transform and quantization processes.

Adder (or combiner) 345 combines the output of motion compensation circuit 325 with the output of IDCT circuit 340. The output of adder 345 is one of the inputs to motion compensation circuit 325. Motion compensation circuit 325 uses the frame data from adder 345 as the input reference signal for determining motion changes in the original input video signal.

Adder (or combiner) 350 receives the original video signal and substracts the reconstructed base layer frame information from adder 345. This gives difference data that represents the enhancement layer information. Discrete cosine transform (DCT) circuit 355 receives the resultant output from adder 350 and transforms it from a spatial domain to a frequency domain. The DCT outputs are shifted by bitplane shift circuit 350. Finally, VLC 365 receives the shifted DCT coefficients and further compresses the data using variable-length coding techniques. The output of VLC 365 comprises the enhancement-layer video stream.

FIG. 4 illustrates exemplary fine granular scalability (FGS) decoder 400 according to one embodiment of the prior art. FGS decoder 400 comprises variable length decoder (VLD) 405, inverse quantization circuit 410, inverse discrete cosine transform (IDCT) 415, adder (or combiner) 420, and motion compensation circuit 425. FGS decoder 400 further comprises variable length decoder 430, bitplane shift circuit 435, inverse discrete cosine transform (IDCT) 440, and adder (or combiner) 445.

VLD 405 receives the transmitted base layer video stream. VLD 405, inverse quantization circuit 410, inverse discrete cosine transform (IDCT) 415, adder 420 and motion compensation circuit 425 essentially reverse the processing performed by adder 305, DCT 310, quantization circuit 315, VLC 320 and motion compensation circuit 325 in FIG. 3. The output of adder 420 is the motion-compensated base layer video stream.

VLD 430 receives the transmitted enhancement layer video stream. VLD 430, bitplane shift circuit 435 and inverse discrete cosine transform (IDCT) circuit 440 essentially reverse the processing performed by DCT circuit 355, bitplane shift circuit 360, and VLC 365 in FIG. 3. The output of IDCT 440 is the decoded enhancement layer video stream. Adder 445 combines the decoded base layer video stream from adder 420 with the decoded enhancement layer video stream to generate the original input video signal in FIG. 3.

In conventional FGS encoder 300, an input video sequence is encoded such that the base layer has a specified data rate at which the quality of the decoded video is lower than that of the original source. Nevertheless, the base layer conforms to a digital video coding standard (such as MPEG-4) and can thereby be independently decoded and displayed. The enhancement layer data is encoded such that the residual information (i.e., the difference between the original video and the decoded base layer) is transmitted in order of decreasing bit significance. In other words, the most significant bit of this residual data is transmitted for an entire video image, followed by the second-most significant, followed by the third-most significant bit, and so forth.

This allows the enhancement layer to be truncated at any point within a video image, depending upon the available network bandwidth. Less transmitted data results in lower video quality. However, all of the data that is actually transmitted data may be used for improving video quality above that of the base layer alone.

Conventional FGS coding is performed in conjunction with the digital encoding of a source video sequence according to the standard (e.g., MPEG-4) used for the base layer. The residual video is encoded in the spatial frequency domain using the Discrete Cosine Transform (DCT) and is subsequently arranged in order of decreasing bit-plane significance. Such encoding requires the base-layer data rate to be specified and is thereby performed as part of the source sequence encoding. FGS coding of digital video, such as on a DVD or transmitted over a satellite or digital cable service, requires trans-coding or decoding of the digital video partially followed by re-encoding at a lower data rate for the base layer and simultaneous coding of the residual video for the enhancement layer. This procedure often proves difficult to perform in real time.

A layered video scheme, such as fine granular scalability (FGS), offers the advantage of always providing the full quality of the original video whenever sufficient bandwidth is available to transmit and receive all of the base layer information and the enhancement layer information. FGS only degrades when the full enhancement layer cannot be transmitted. Consequently, the trans-rating of a first video stream having a higher data rate to a second video stream (which serves as a base layer) having a lower rate and the simultaneous coding of the residual between the higher-rate and lower-rate streams permit the methods of trans-rating and FGS layered coding to be combined. This also allows taking advantage of prioritized streaming technologies to leverage MAC layer QoS support defined in IEEE 802.11e to achieve better and faster adaptation to the varying channel conditions.

In the present invention, the trans-coded video stream and the original stream are both decoded to generate the FGS layer stream in such a manner that no additional encoding is required beyond the FGS layer itself (i.e., no re-encoding of the base layer is necessary). In a digital video coding method where motion estimation and compensation are used in the video compression, inaccurate decoding can result in prediction drift, since a video image can serve as a reference for decoding a subsequently-transmitted image.

In conventional FGS encoding, the residual video for the enhancement layer is computed after the base-layer coding, which includes motion prediction. This allows the base layer to be decoded with no prediction drift in the absence of the enhancement layer. However, trans-rating of a video stream results in a video stream whose DCT coefficients have been re-quantized. When decoded, the DCT coefficients could have different values than were used for the original motion encoding and thereby cause prediction drift.

If a video stream is trans-rated to a reduced-rate stream that serves as the base layer for an FGS layered stream, the original stream must be fully decoded, along with the trans-coded stream, before the FGS enhancement layer can be encoded. However, the FGS base layer has some prediction drift when decoded without an enhancement layer. When the latter is fully present, however, its encoding relative to the original stream ensures that the quality of the decoded images is identical to that obtained by decoding the original video stream. In particular, the effects of prediction drift introduced by the trans-rating will not be present.

FIG. 5 illustrates exemplary transcoder 500 for fine granular scalability (FGS) according to one embodiment of the present invention. Transcoder 500 may be implemented as part of video encoder 114. Transcoder 500 comprises MPEG decoder 505, fine granular scalability (FGS) enhancement layer encoder 510, MPEG decoder 540, and MPEG video transrater 550. FGS enhancement layer encoder 510 further comprises adder (or combiner) 515, discrete cosine transform (DCT) 520, bitplane shift circuit 525, and variable length coder (VLC) 530. MPEG video trans-rater 550 converts an input digital video stream having a higher rate, R1, to a second digital video stream having a lower data rate, R2. MPEG decoder 505 decodes the original video stream at rate R1. MPEG decoder 540 decodes the trans-rated base-layer stream at rate R2. FGS enhancement layer encoder 510 encodes the residual of decoders 505 and 540. Adder (or combiner) 515 detects the difference between the two input signals to FGS enhancement layer encoder 510. DCT 520, bitplane shift circuit 525, and VLC 530 process the FGS enhancement layer signal in a manner similar to DCT 355, bitplane shift circuit 360, and VLC 365 in FIG. 3.

This method has the advantage of using only standard decoders, but does not require encoders, which are much more complicated and, depending upon the encoding method and parameters, may result in lower image quality in applications where an inexpensive encoder is desired. Another advantage is that this method can work with any trans-rating scheme, so that any conventional trans-rater may be used.

Since FGS enhancement-layer coding is fairly straightforward, the present invention permits effective and economical real-time trans-rating of a digital video stream into a base-layer of a desired data rate and a corresponding FGS enhancement layer. If a trans-rater that accepts analog or pixel domain input is used, MPEG decoder 505 for the original video stream is not required and may be replaced by the appropriate converter to the video format required by FGS enhancement layer encoder 510.

Although FGS encoding is conventionally performed such that the residual is computed in the picture domain and relative to the prediction-coded base layer, it has been demonstrated that, in an FGS encoder, the residual may instead be computed in the DCT coefficient domain using the pre-quantized DCT and the subsequently de-quantized DCT in the motion prediction loop of the base-layer encoder. This eliminates the DCT operation otherwise required for the FGS enhancement-layer encoding. The decoded video that results from a stream encoded in this manner differs very slightly in the picture domain from that of one encoded using the conventional FGS method shown in FIG. 2 above. But this difference is nevertheless very small. In particular, it results in a small amount of prediction drift of the decoded and displayed video. This drift is apart and distinct from that caused by trans-rating.

This result may be used to simplify the FGS trans-coding method, as shown in FIG. 6 below for the case of a trans-rater that performs its function by de-quantizing DCT coefficients and re-quantizing them using a different quantization factor, thereby resulting in the desired base-layer data rate.

FIG. 6 illustrates exemplary transcoder 600 for fine granular scalability (FGS) according to another embodiment of the present invention. Transcoder 600 may be implemented as part of video encoder 114. Transcoder 600 comprises variable-length decoder 605, inverse quantization circuit 610, quantization circuit 615, variable-length coder (VLC) 620, quantization coefficients block 625 and re-quantization coefficients block 650. VLD 605 receives a high-rate MPEG video stream at rate R1 and decodes the base layer and enhancement layer to produce the quantized discrete cosine transform (DCT) coefficients. VLD 605 also extracts the quantization coefficients from the stream or identifies predefined quantization coefficients, and the quantization coefficients are stored in quantization coefficients block 625. Inverse quantization circuit 610 receives the quantized DCT coefficients and uses the quantization coefficients from quantization coefficients block 625 to produce de-quantized DCT coefficients at rate R1.

Re-quantization coefficients block 650 determines new (or re-quantization) coefficients suited to the new, lower video data rate (i.e., video data rate conversion ratio). Quantization circuit 615 uses the re-quantization coefficients to re-quantize the output of inverse quantization circuit 610 at the new data rate R2, thereby producing a stream of re-quantized DCT coefficients at rate R2. VLC 620 then encodes the re-quantized DCT coefficients to produce a base layer video stream at the desired low-rate, R2.

Inverse quantization circuit 635 receives the re-quantized DCT coefficients from quantization circuit 615 and produces de-quantized DCT coefficients at rate R2. Adder (or combiner) 630 subtracts the output of inverse quantization circuit 635 from the output of inverse quantization circuit 610, thereby producing a residual signal. The residual signal is shifted by bitplane shift circuit 640 and then encoded by VLC 645. The coded output of VLC 645 comprises the FGS enhancement layer video stream.

In this arrangement, the residual is computed directly from the de-quantized coefficients in the base-layer trans-rater and the de-quantization of the same re-quantized coefficient in the trans-rater. Such a scheme eliminates the need for both decoders, requiring only a base-layer trans-coder of the type described above and an FGS enhancement-layer coder in the DCT coefficient domain that further eliminates the need for its DCT computation.

Unlike the prior art methods, the present invention introduces prediction drift into both the base and enhancement layers due to the effects of trans-rating and of performing the FGS residual computation in the DCT domain. Consequently, it is best suited for applications in which the number of pictures and especially the number of reference pictures (MPEG I or P pictures) in a Group of Pictures (GOP) is always small enough that the accumulated prediction error will be imperceptible or at least not objectionable.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

1. A digital video transcoder (500) comprising:
a first decoder (505) capable of receiving an input digital video stream having a first data rate (R1) and decoding said input digital video stream to produce a first decoded video stream;
a transrater (550) capable of receiving said input digital video stream having said first data rate (R1) and re-encoding said input digital video stream to produce a base layer video stream having a lower data rate (R2) than said input digital video stream;
a second decoder (540) capable of receiving said base layer video stream having said second data rate (R2) and decoding said base layer video stream to produce a second decoded video stream; and
an enhancement layer encoder (510) capable of receiving said first decoded video stream and said second decoded video stream and generating therefrom an enhancement layer video stream.

2. The digital video transcoder (500) as set forth in claim 1, wherein said first and second decoders comprise MPEG video decoders and said transrater comprises an MPEG video transrater.

3. The digital video transcoder (500) as set forth in claim 1, wherein said enhancement layer video stream corresponds to differences between said first and second decoded video streams.

4. The digital video transcoder (500) as set forth in claim 3, wherein said enhancement layer encoder (510) encodes residual signals from said first and second decoders.

5. The digital video transcoder (500) as set forth in claim 4, wherein said enhancement layer encoder (510) comprises a fine granular scalability (FGS) encoder.

6. The digital video transcoder (500) as set forth in claim 5, wherein said enhancement layer encoder (510) comprises a detection circuit capable of detecting a difference between said first and second decoded video streams and a variable length coder for encoding said difference.

7. A method of transcoding digital video comprising the steps of:
receiving an input digital video stream having a first data rate (R1);
decoding the input digital video stream to produce a first decoded video stream;
re-encoding the input digital video stream to produce a base layer video stream having a lower data rate (R2) than the input digital video stream;
decoding the base layer video stream to produce a second decoded video stream; and
generating an enhancement layer video stream from the first decoded video stream and the second decoded video stream.

8. The method as set forth in claim 7, wherein the input digital video stream comprises an MPEG video stream.

9. The method as set forth in claim 7, wherein the enhancement layer video stream corresponds to differences between the first and second decoded video streams.

10. The method as set forth in claim 9, wherein the step of generating comprises the step of encoding residual signals associated with the first decoded video stream and the second decoded video stream.

11. The method as set forth in claim 10, wherein the enhancement layer video stream comprises a fine granular scalability (FGS) layer video stream.

12. The method as set forth in claim 1, wherein the step of generating comprises the sub-steps of detecting a difference between the first and second decoded video streams and encoding the difference.

13. A computer program embodied on a computer readable medium and operable to be executed by a processor, the computer program comprising computer readable program code for:
receiving an input digital video stream having a first data rate (R1);
decoding the input digital video stream to produce a first decoded video stream;
re-encoding the input digital video stream to produce a base layer video stream having a lower data rate (R2) than the input digital video stream;
decoding the base layer video stream to produce a second decoded video stream; and
generating an enhancement layer video stream from the first decoded video stream and the second decoded video stream.

14. The computer program embodied on a computer readable medium as set forth in claim 13, wherein the input digital video stream comprises an MPEG video stream.

15. The computer program embodied on a computer readable medium as set forth in claim 13, wherein the enhancement layer video stream corresponds to differences between the first and second decoded video streams.

16. The computer program embodied on a computer readable medium as set forth in claim 15, wherein the step of generating comprises the step of encoding residual signals associated with the first decoded video stream and the second decoded video stream.

17. The computer program embodied on a computer readable medium as set forth in claim 16, wherein the enhancement layer video stream comprises a fine granular scalability (FGS) layer video stream.

18. The computer program embodied on a computer readable medium as set forth in claim 17, wherein the step of generating comprises the sub-steps of detecting a difference between the first and second decoded video streams and encoding the difference.

19. A video transmission system comprising:
a video encoder (114) capable of receiving a stream of video frames from one of: i) a storage device (115) and ii) a video frame source (112), wherein said video encoder (114) encodes said video frames to produce an input digital video stream, wherein said video encoder (114) further comprises a digital video transcoder (500) comprising:
a first decoder (505) capable of receiving said input digital video stream having a first data rate (R1) and decoding said input digital video stream to produce a first decoded video stream;
a transrater (550) capable of receiving said input digital video stream having said first data rate (R1) and re-encoding said input digital video stream to produce a base layer video stream having a lower data rate (R2) than said input digital video stream;
a second decoder (540) capable of receiving said base layer video stream having said second data rate (R2) and decoding said base layer video stream to produce a second decoded video stream; and
an enhancement layer encoder (510) capable of receiving said first decoded video stream and said second decoded video stream and generating therefrom an enhancement layer video stream; and
a buffer capable of storing said base layer video stream and said enhancement layer video stream prior to transmission over one of: i) a wireless network and ii) a wireline network.

20. The video transmission system as set forth in claim 19, wherein said first and second decoders comprise MPEG video decoders and said transrater comprises an MPEG video transrater.

21. The video transmission system as set forth in claim 19, wherein said enhancement layer video stream corresponds to differences between said first and second decoded video streams.

22. The video transmission system as set forth in claim 21, wherein said enhancement layer encoder (510) encodes residual signals from said first and second decoders.

23. The video transmission system as set forth in claim 22, wherein said enhancement layer encoder (510) comprises a fine granular scalability (FGS) encoder.

24. The video transmission system as set forth in claim 23, wherein said enhancement layer encoder (510) comprises a detection circuit capable of detecting a difference between said first and second decoded video streams and a variable length coder for encoding said difference.

25. A transmittable video signal produced by the steps of:
receiving an input digital video stream having a first data rate (R1);
decoding the input digital video stream to produce a first decoded video stream;
re-encoding the input digital video stream to produce a base layer video stream having a lower data rate (R2) than the input digital video stream;
decoding the base layer video stream to produce a second decoded video stream; and
generating an enhancement layer video stream from the first decoded video stream and the second decoded video stream, wherein the transmittable video signal comprises the base layer video stream and the enhancement layer video stream.

26. A digital video transcoder (600) comprising:
a decoder (605) capable of receiving an input digital video stream having a first data rate (R1) and decoding said input digital video stream to produce first quantized discrete cosine transform (DCT) coefficients;
a first inverse quantizer (610) capable of receiving said first quantized DCT coefficients and producing first de-quantized DCT coefficients at said first data rate (R1);
a re-quantizer (650) capable of determining quantization coefficients associated with a second data rate (R2);
a quantizer (615) capable of quantizing said first de-quantized DCT coefficients at said second data rate (R2) using said quantization coefficients to produce second quantized DCT coefficients; and
a first coder (620) capable of encoding said second quantized DCT coefficients to produce a base layer video stream at said second data rate (R2).

27. The digital video transcoder as set forth in claim 26, further comprising:
a second inverse quantizer (635) capable of receiving said second quantized DCT coefficients and producing second de-quantized DCT coefficients at said second data rate (R2);
a combiner (630) capable of subtracting said second de-quantized DCT coefficients from said first de-quantized DCT coefficients to produce a residual signal;
a shifter (640) capable of bitplane shifting said residual signal; and
a second coder (645) capable of receiving said shifted residual signal and generating therefrom an enhancement layer video stream.

28. The digital video transcoder as set forth in claim 27, wherein:
the decoder (605) comprises a variable length decoder; and
the first and second coders (620, 645) comprise variable length coders.

29. A method of transcoding digital video comprising the steps of:
receiving an input digital video stream having a first data rate (R1);
decoding said input digital video stream to produce first quantized discrete cosine transform (DCT) coefficients;
producing first de-quantized DCT coefficients at said first data rate (R1) using said first quantized DCT coefficients;
determining quantization coefficients associated with a second data rate (R2);
quantizing said first de-quantized DCT coefficients at said second data rate (R2) using said quantization coefficients to produce second quantized DCT coefficients; and
encoding said second quantized DCT coefficients to produce a base layer video stream at said second data rate (R2).

30. The method as set forth in claim 29, further comprising:
producing second de-quantized DCT coefficients at said second data rate (R2) using said second quantized DCT coefficients;
subtracting said second de-quantized DCT coefficients from said first de-quantized DCT coefficients to produce a residual signal;
bitplane shifting said residual signal; and
generating an enhancement layer video stream using said shifted residual signal.

31. The method as set forth in claim 30, wherein:
decoding said input digital video stream comprises variable length decoding said input digital video stream;
encoding said second quantized DCT coefficients comprises variable length encoding said second quantized DCT coefficients; and
generating said enhancement layer video stream comprises generating said enhancement layer video stream using variable length encoding.

32. A computer program embodied on a computer readable medium and operable to be executed by a processor, the computer program comprising computer readable program code for:
receiving an input digital video stream having a first data rate (R1);
decoding said input digital video stream to produce first quantized discrete cosine transform (DCT) coefficients;
producing first de-quantized DCT coefficients at said first data rate (R1) using said first quantized DCT coefficients;
determining quantization coefficients associated with a second data rate (R2);
quantizing said first de-quantized DCT coefficients at said second data rate (R2) using said quantization coefficients to produce second quantized DCT coefficients; and
encoding said second quantized DCT coefficients to produce a base layer video stream at said second data rate (R2).

33. The computer program embodied on a computer readable medium as set forth in claim 32, further comprising computer readable program code for:
producing second de-quantized DCT coefficients at said second data rate (R2) using said second quantized DCT coefficients;
subtracting said second de-quantized DCT coefficients from said first de-quantized DCT coefficients to produce a residual signal;
bitplane shifting said residual signal; and
generating an enhancement layer video stream using said shifted residual signal.

34. The computer program embodied on a computer readable medium as set forth in claim 33, wherein the input digital video stream comprises an MPEG video stream.
